(19) United States
(12) Patent Application Publication
(10) Pub. No.: US 2025/0021965 A1
(43) Pub. Date: Jan. 16, 2025

(54) TOKEN TRANSACTION AGGREGATOR FOR MINTING TOKENS ON A BLOCKCHAIN NETWORK

(71) Applicant: Magic Labs, Inc., San Francisco, CA (US)

(72) Inventors: Benjamin Griffin, New York, NY (US); Karl Jin, Keene, NH (US)

(21) Appl. No.: 18/770,190

(22) Filed: Jul. 11, 2024

Related U.S. Application Data
(60) Provisional application No. 63/513,059, filed on Jul. 11, 2023.

(51) Int. Cl. G06Q 20/36; H04L 9/08

(52) U.S. Cl. CPC G06Q 20/367; H04L 9/0894

(57) ABSTRACT

This disclosure relates to systems, methods, and computer readable media that batch token minting transactions (e.g., for non-fungible tokens (NFTs), fungible tokens (FTs), and/or semi-fungible tokens (SFTs)) across multiple developers and token contract types (e.g., ERC 721 and ERC 1155). Specifically, the systems, methods, and computer readable media include a transaction aggregator contract that is separate from the underlying token contract that is used for minting the tokens. The transaction aggregator contract batches requested minting transactions outside the underlying token contract. Because the transaction aggregator systems described herein are independent from the underlying token contracts, the token transaction aggregator systems allow developers to use any desired token contract type.

### TECHNICAL FIELD

This disclosure relates generally to systems, methods, and computer readable media to perform token transaction aggregation for minting tokens on a blockchain network. More particularly, the systems, methods, and computer readable media are configured to allow for the batching of minting transactions across multiple developers and token contract types.

### BACKGROUND

Non-fungible tokens (NFTs) are unique assets within a new digital economy that recently has experienced a wave of popularity and gained mainstream attention. The minting process for NFTs (and other types of tokens, such as fungible tokens (FTs) or semi-fungible tokens (SFTs)) can be expensive, consume a great deal of energy, and may have transaction speed issues, e.g., based on the particular blockchain network they reside on. While the transaction speed and energy consumption may be of little concern when minting individual tokens, transaction speed and energy becomes critical when issuing thousands—or even millions—of tokens across multiple enterprises and/or developers. For example, the distributed nature of the blockchain network could cause throughput problems when attempting to mint a relatively large number of tokens.

Thus, the subject matter of the present disclosure is directed to overcoming, or at least reducing the effects of, one or more of the problems set forth above. To address these and other issues, new techniques and system architectures are disclosed herein that enable token transaction aggregation, resulting in improved minting performance and developer experiences.

### BRIEF DESCRIPTION OF THE DRAWINGS

FIG. 1 is a block diagram of an NFT transaction aggregator system that batches minting transactions for one or more developers, according to one or more disclosed embodiments.

FIG. 2 is a flowchart illustrating an exemplary method for performing the various operations described herein, according to one or more disclosed embodiments.

FIG. 3 is a block diagram illustrating a computer which could be used to execute the various operations described herein, according to one or more of disclosed embodiments.

### DETAILED DESCRIPTION

The token transaction aggregator systems, methods, and computer readable media disclosed herein can improve the minting process by offering a simplified minting API to developers—while potentially reducing mint processing times and/or costs. With the token transaction aggregator systems disclosed herein, transactions initiated across multiple developers can be batched together into a single transaction, e.g., based on contract types and/or contract addresses. Because the token transaction aggregator system is separate from underlying token smart contracts, the token transaction aggregator system allows developers to use any desired token contract type, which can also be referenced as the desired token standard. Although this disclosure generally describes the token aggregator system as interacting with ERC 721 and ERC 1155 non-fungible token contract types, the token transaction aggregator system is not limited to interacting with such non-fungible token contract types. Indeed, the token transaction aggregator systems described herein can interact with other smart contract types used to mint a variety of tokens (e.g., fungible tokens (FTs), NFTs, and/or semi fungible tokens (SFTs)).

In one implementation, the token transaction aggregator system includes a database to store incoming minting requests from a developer and one or multiple long running workers (LRWs) to group such minting requests to a transaction aggregator contract. The token transaction aggregator system may include a separate long running worker for each token contract type. As an example, the token transaction aggregator could include one long running worker for ERC 721 smart contracts and another long running worker for ERC 1155 smart contracts.

Each long running worker may send its grouped transactions to the transaction aggregator contract. The token transaction aggregator contract then groups the grouped transactions by contract address and bundles the grouped transaction into a single transaction. The single transactions are then sent to the appropriate token contracts to mint the single transaction within a block of a blockchain. In other words, rather than minting each minting request made by a developer onto different blocks of a blockchain, the token transaction aggregator contract system bundles the requests from the developer to a single transaction stored as a single block of a blockchain. By doing so, the token transaction aggregator contract system reduces the delay and processing time for the group of minting requests. After minting, the token transaction aggregator system sends the minted token to an escrow wallet (or directly to the end user wallets).

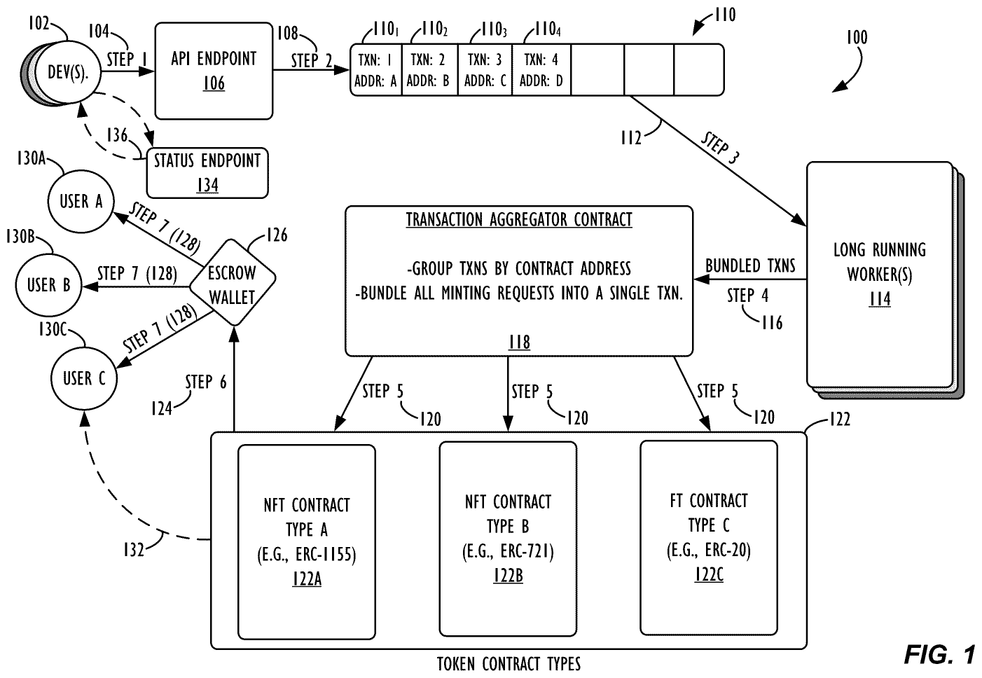

Referring now to FIG. 1, a block diagram of a token transaction aggregator system 100 is shown that batches minting transactions for one or more developers 102, according to one or more disclosed embodiments. As will be explained herein, the token transaction aggregator system 100 can reduce the fixed minting cost by reducing the number of transactions to a single transaction per token contract type. As an example, minting tokens are typically associated with a fixed or flat fee cost (e.g., a gas fee) and a variable minting fee cost. By bundling the minting requests to a single transaction, the token transaction aggregator system 100 eliminates duplicative fixed or flat fee costs associated with each minting request.

FIG. 1 illustrates the minting of a token to the transaction aggregator contract when the payment is cryptocurrency. As will be discussed, in an alternative design, the token transaction aggregator system could mint an NFT token directly to the user wallet. Minting directly to the user wallet could improve performance and utilize less gas for NFT airdrops (i.e., NFTs that are free or require no payment by the recipient) or when payment processing is handled by a third party or is made with fiat currency.

At step 1 (104) of FIG. 1, a developer 102 sends one or more requests to mint one or more tokens (e.g., NFTs) using a call to an API endpoint 106. The API call could include the ID for the underlying, registered contract ID, token quantity, user wallet destination address, and/or other address contract arguments. According to some implementations, in order to use the NFT minting (and/or delivery) API(s), a developer will need a smart contract deployed on-chain and registered with the token transaction aggregator system 100. The developer will then be able to sign in and create an application(s) to leverage the token transaction aggregator system 100.

At step 2 (108) of FIG. 1, a database 110 is utilized to store a queue of the pending minting or transaction requests 110n from one or more developers. For example, a minting or transaction request #1 (110₁) has a contract address “A,” while a minting or transaction request #2 (110₂) has a contract address “B,” a minting or transaction request #3 (110₃) has a contract address “C,” a minting or transaction request #4 (110₄) has a contract address “D,” and so forth.

At step 3 (112) of FIG. 1, one or more working entities, also referred to herein as “long running workers” or LRWs 114 obtain the pending minting or transaction requests from the database 110 and group them according to token contract types. The token transaction aggregator system 100 may be configured to have a separate worker entity 114 for each token contract type. For example, one worker entity (e.g., 114₁, not shown) could be used to group ERC 721 contracts, while another worker entity (e.g., 114₂, not shown) could be used to group ERC 1155 contracts, and so forth.

Exemplary pseudocode that could be used to perform a minting transaction for an ERC 721 contract may comprise the following (where <sk_live_xxxxxxx> would be replaced by the developer's assigned secret key, and <contract_id> would be replaced with a provided contract ID):

```
const magic_resp = await fetch(“<https://nft-
api.magic.link/v1/nft/721/start_mint>”, {
  method: “POST”,
  headers: {
    “Content-Type”: “application/json”,
    “X-Magic-Secret-Key”: <sk_live_xxxxxxx>,
  },
  body: JSON.stringify({
    contract_id: <contract_id>,
    quantity: int,
    destination_address: str,
  })
})
const magic_json = await magic_resp.json( )
const request_id = magic_json.data[‘request_id’]
```

Exemplary pseudocode that could be used to perform a minting transaction for an ERC 1155 contract may comprise the following (again, where <sk_live_xxxxxxx> would be replaced by the developer's assigned secret key, and <contract_id> would be replaced with a provided contract ID):

```
const magic_resp = await fetch(“<https://nft-api.magic.link/
v1/nft/1155/start_mint>”, {
  method: “POST”,
  headers: {
    “Content-Type”: “application/json”,
    “X-Magic-Secret-Key”: <sk_live_xxxxxxx>,
  },
  body: JSON.stringify({
    contract_id: <contract_id>,
    token_id: int,
    quantity: int,
    destination_address: str,
  })
})
const magic_json = await magic_resp.json( )
const request_id = magic_json.data[‘request_id’]
```

At step 4 (116) of FIG. 1, the transaction aggregator contract 118 receives the grouped transaction request from the different worker entities 114 and periodically batches the requested transactions. The transaction aggregator contract 118 groups the requested transactions according to the token contract types and/or contract addresses and submits the grouped, requested transactions into a single transaction. The transaction aggregator contract 118 sends the single transaction to the appropriate underlying token contract for minting. As part of the process of registering the underlying token contract types (e.g., 122A-122C), the underlying contract must give permission to the transaction aggregator contract 118.

As may be appreciated, there may be some savings on gas by bundling transactions, e.g., by eliminating any “flat fee” or per-transaction minting costs. There may also be some time savings provided by bundling transactions. For example, rather than waiting on block chain consensus on 100 individual token transactions, according to the present embodiments, the blockchain may provide consensus on all 100 token transactions at one time.

In some embodiments, the transaction aggregator contract 118 may use a static limit to determine the number of transactions that can be grouped into a single transaction. A limit may need to be set in order to avoid going over the gas limit, which may cause a failure to process all of the minting requests. In other embodiments, the transaction limit can be set dynamically, e.g., according to a variety of conditions, such as network congestion.

In some alternative embodiments, a “fleet” approach may be combined with the LRW-based approaches described herein. For example, an individual wallet may be used for each bundled transaction type. In some designs, a “nonce” (i.e., an incrementing number) may be used by the blockchain to represent the number of transactions an individual wallet has completed. The nonce may be used to prevent an individual wallet from submitting multiple transactions to the blockchain simultaneously, since, if a wallet sends multiple requests simultaneously, only one of them will be processed successfully.

At step 5 (120) of FIG. 1, the transaction aggregator contract 118 sends the single transactions to the appropriate underlying token contracts (e.g., 122A-122C) for minting.

At step 6 (124) of FIG. 1, the underlying contracts (e.g., 122A-122C) send the minted tokens to an escrow wallet 126. Once payment has been received and/or confirmed, the minted tokens are sent to the individual end user wallets (e.g., 130A-130C) at step 7 (128) of FIG. 1.

In one alternative design, as shown by dashed line 132, the underlying contracts (e.g., 122A-122C) can instead send the minted tokens directly to the end user wallets (e.g., 130A-130C), and thus avoid sending them to escrow wallet 126. This design may be appropriate, e.g., for airdrop NFTs and/or when payment is confirmed by third parties. In such designs, it would not be necessary for either customers or end users to have any cryptocurrency in order to get an NFT and/or use the minting services. As may now be appreciated, airdrops also allow end users to easily claim, mint, and/or directly receive free NFTs.

In some designs, individual developers 102 may also poll 136 (or be pushed information from) a status endpoint 134. Status endpoint 134 may be able to accept an array of one or more request IDs (e.g., a list of user wallets and/or transaction IDs) and return the status of each of those minting requests, e.g., as tracked in the database 110, to the respective requesting entity, such as a developer 102.

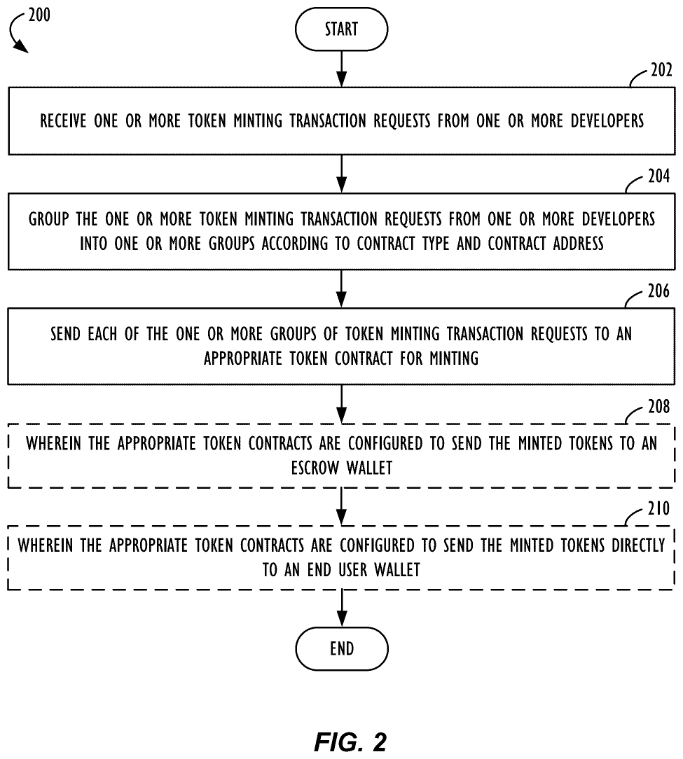

Turning now to FIG. 2, a flowchart for a method 200, is shown. First at block 202, the method 200 may begin by receiving one or more token minting transaction requests from one or more developers. Next, at block 204, the method 200 may continue by grouping the one or more token minting transaction requests from one or more developers into one or more groups according to token contract type and/or contract address. Next, at block 206, the method 200 may continue by sending each of the one or more groups of token minting transaction requests to an appropriate token contract for minting.

As mentioned above, in some embodiments, at block 208, the appropriate token contracts are configured to send the minted tokens to an escrow wallet. In other embodiments, at block 210, the appropriate token contracts are configured to send the minted tokens directly to an end user wallet(s).

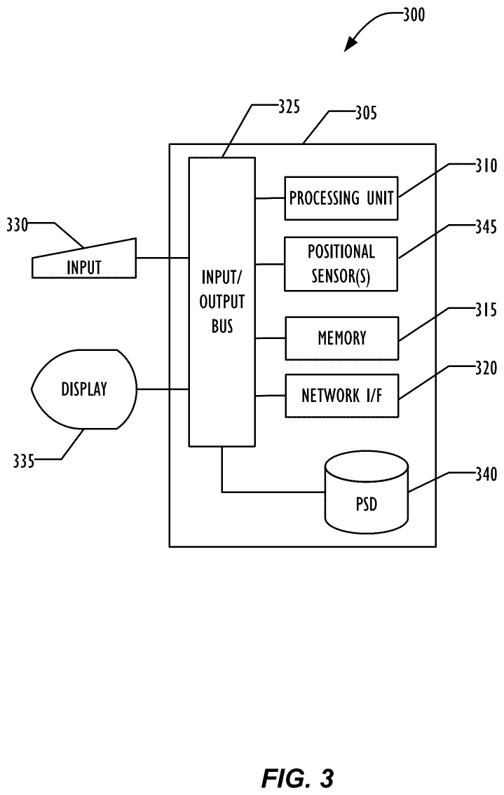

Referring now to FIG. 3, an example processing device 300 for use in the various operations described herein is illustrated in block diagram form, according to one or more disclosed embodiments. Processing device 300 may serve in, e.g., a mobile phone, end user computer, or a server computer. Example processing device 300 comprises a system unit 305 which may be optionally connected to an input device 330 (e.g., keyboard, mouse, touch screen, etc.) and display 335. A program storage device (PSD) 340 (sometimes referred to as a hard disk, flash memory, or non-transitory computer readable medium) is included with the system unit 305. In some embodiments, the instructions stored on the PSD or non-transitory computer-readable medium may be in the form of a software development kit (SDK) installation package or a web service. In other embodiments, such instructions could be embodied in the form of code running on a server computer, such as exemplary processing device 300.

Also included with system unit 305 may be a network interface 320 for communication via a network (either cellular or computer) with other mobile and/or embedded devices (not shown). Network interface 320 may be included within system unit 305 or be external to system unit 305. In either case, system unit 305 will be communicatively coupled to network interface 320. Program storage device 340 represents any form of non-volatile storage including, but not limited to, all forms of optical and magnetic memory, including solid-state storage elements, including removable media, and may be included within system unit 305 or be external to system unit 305. Program storage device 340 may be used for storage of software to control system unit 305, data for use by the processing device 300, or both.

System unit 305 may be programmed to perform methods in accordance with this disclosure. System unit 305 comprises one or more processing units, input-output (I/O) bus 325 and memory 315. Access to memory 315 can be accomplished using the communication bus 325. Processing unit 310 may include any programmable controller device including, for example, a mainframe processor, a mobile phone processor, or desktop class processor. Memory 315 may include one or more memory modules and comprise random access memory (RAM), read only memory (ROM), programmable read only memory (PROM), programmable read-write memory, and solid-state memory. As also shown in FIG. 3, system unit 305 may also include one or more positional sensors 345, which may comprise an accelerometer, gyroscope, global positioning system (GPS) device, or the like, and which may be used to track the movement of the device.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and it may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other, and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A method, comprising:
receiving one or more token minting transaction requests from one or more developers;
grouping the one or more token minting transaction requests from one or more developers into one or more groups according to contract type and contract address; and
sending each of the one or more groups of token minting transaction requests to an appropriate token contract for minting.

2. The method of claim 1, wherein the appropriate token contracts are configured to send the minted tokens to an escrow wallet.

3. The method of claim 1, wherein the appropriate token contracts are configured to send the minted tokens directly to an end user wallet.

4. The method of claim 1, wherein at least one of the token contract types comprises: ERC 721 or ERC 1155.

5. The method of claim 1, wherein the grouping of the one or more token minting transaction requests is performed by one or more long running workers (LRWs).

6. The method of claim 5, wherein a separate LRW is assigned to each token contract type.

7. A non-transitory computer-readable medium, readable by at least one processor and comprising instructions stored thereon to cause the at least one processor to:
receive one or more token minting transaction requests from one or more developers;
group the one or more token minting transaction requests from one or more developers into one or more groups according to contract type and contract address; and
send each of the one or more groups of token minting transaction requests to an appropriate token contract for minting.

8. The non-transitory computer-readable medium of claim 7, wherein the appropriate token contracts are configured to send the minted tokens to an escrow wallet.

9. The non-transitory computer-readable medium of claim 7, wherein the appropriate token contracts are configured to send the minted tokens directly to an end user wallet.

10. The non-transitory computer-readable medium of claim 7, wherein at least one of the token contract types comprises: ERC 721 or ERC 1155.

11. The non-transitory computer-readable medium of claim 7, wherein the grouping of the one or more token minting transaction requests is performed by one or more long running workers (LRWs).

12. The non-transitory computer-readable medium of claim 11, wherein a separate LRW is assigned to each token contract type.

13. The non-transitory computer-readable medium of claim 7, wherein the instructions stored on the non-transitory computer-readable medium comprise a software development kit (SDK).

14. An electronic device, comprising:
one or more processors;
memory; and
control logic, implemented using the one or more processors and memory, configured to perform operations, comprising:
receiving one or more token minting transaction requests from one or more developers;
grouping the one or more token minting transaction requests from one or more developers into one or more groups according to contract type and contract address; and
sending each of the one or more groups of token minting transaction requests to an appropriate token contract for minting.

15. The electronic device of claim 14, wherein the appropriate token contracts are configured to send the minted tokens to an escrow wallet.

16. The electronic device of claim 14, wherein the appropriate token contracts are configured to send the minted tokens directly to an end user wallet.

17. The electronic device of claim 14, wherein at least one of the token contract types comprises: ERC 721 or ERC 1155.

18. The electronic device of claim 14, wherein the grouping of the one or more token minting transaction requests is performed by one or more long running workers (LRWs).

19. The electronic device of claim 18, wherein a separate LRW is assigned to each token contract type.

20. The electronic device of claim 14, wherein the control logic comprises a software development kit (SDK).
